(19) United States
(12) Patent Application Publication
(10) Pub. No.: US 2020/0016726 A1
(43) Pub. Date: Jan. 16, 2020

(54) CAM LOCK WRENCH

(71) Applicant: Nick Heintz, White Oak, TX (US)

(72) Inventor: Nick Heintz, White Oak, TX (US)

(21) Appl. No.: 16/419,296

(22) Filed: May 22, 2019

Related U.S. Application Data
(60) Provisional application No. 62/697,273, filed on Jul. 12, 2018.

(51) Int. Cl. B25B 13/24

(52) U.S. Cl. CPC B25B 13/24

(57) ABSTRACT

The present invention provides a wrench for operating cam lock levers. The cam lock lever wrench provides a handle connected to a wrench head that is configured to engage the cam lock lever in a cavity and in a channel, enabling ease of locking and ease of opening a cam lock. Wrench heads of various sizes may be used for cam lock levers of respective various sizes. The handle and wrench head may be fixed together, may be of one piece, or the wrench head may feature a socket such as those used for socket wrenches, and the handle may have a male portion of a socket wrench fitting of a complimentary size to the socket. A wide variety of handles may be used. Some surfaces of the wrench head may have traction enhancements. Some edges of the wrench head may be rounded.

### FIELD OF ART

The present invention relates to a tool for use in oil fields, farms, chemical facilities, firefighting, and other industrial facilities. The present invention more particularly relates to a wrench for opening and closing the cam locks used to join sections of hose or pipe together.

### BACKGROUND OF THE INVENTION

Cam locks are used to join pipes or hoses together in various industrial operations, such as in oil fields, chemical plants, chemical trucks, firefighting, and farming. FIG. 8 shows a prior art section of hose 802 attached to a coupling 808 having a circumferential lip 806 and circumferential groove 804, as shown. FIG. 9 shows a second section of prior art hose 910 having an attachment 908 to a complementary coupling 902 which has a radially outward support 904 housing a pivot 906 for cam lock lever 502 (one of two labeled), as shown. Cam lock lever 502 has a cam lock lever head 504. Cam lock lever 502 is shown in the locked position. FIG. 10 shows the inside of complimentary coupling 902. The cam portion 1002 of cam lock lever 502 is shown in the locked position. In the locked position, cam portion 1002 enters circumferential groove 804 of coupling 808 and exerts a force against circumferential lip 806 to urge circumferential lip 806 against resilient seal 1004. The necessity of compressing the resilient seal 1004 to ensure a joint that does not leak is the reason that a lot of force is required to operate the cam lock lever 502. FIG. 11 shows the cam lock lever 502 in the unlocked position.

Cam lock levers 502 are difficult to operate and prone to breakage. The couplings for the pipes or hoses frequently have debris on the resilient seal 1004 and/or the cam lock lever 502. If the first cam lock closure is misaligned for any reason, the second cam lock is nearly impossible to close. As a result, unauthorized methods of moving the cam lock levers 502 are frequently used, such as bashing the cam lock lever 502 with a rock or heavy tool, resulting in breakage of the cam lock lever 502. Breakage of the cam lock lever 502 can result is a loose connection as the cam is not fully rotated. Loose connections lead to spills that endanger human safety and incur HazMat cleanup costs and fines. Because of the difficult environments in which cam lock levers 502 are used, most first attempts at coupling pipes and hoses fail. What is needed is a way to close cam locks with reduced breakage.

### SUMMARY OF THE INVENTION

The present invention provides a wrench for operating cam lock levers. The cam lock lever wrench provides a handle connected to a head that is configured to engage the cam lock lever at two points, enabling ease of locking and ease of unlocking a cam lock. Heads of various sizes may be used for cam lock levers of respective various sizes. The handle and head may be fixed together, or the head may feature a socket such as those used for socket wrenches, and the handle may have a male portion of a socket wrench fitting of a complimentary size to the socket. A wide variety of handles may be used.

### DESCRIPTION OF THE FIGURES OF THE DRAWINGS

The present invention will hereinafter be described in conjunction with the following drawing figures, wherein like numerals denote like elements, and hundred(s) digits of reference numbers are the figure numbers in regard to which the referenced item is first referenced.

FIG. 1 is a right-side elevation view illustrating an exemplary embodiment of a cam lock wrench, according to a preferred embodiment of the present invention;

FIG. 2 is a left-side elevation view illustrating the exemplary embodiment of the cam lock wrench of FIG. 1, according to a preferred embodiment of the present invention;

FIG. 3 is a front-end elevation view illustrating the exemplary embodiment of the cam lock wrench of FIG. 1, according to a preferred embodiment of the present invention;

FIG. 4 is a rear-end elevation view illustrating the cam lock wrench of FIG. 1, according to a preferred embodiment of the present invention;

FIG. 5 is a front-end elevation view illustrating the exemplary embodiment of the cam lock wrench of FIG. 1 engaged with a cam lock lever, according to a preferred embodiment of the present invention;

FIG. 6 is a front-side perspective view illustrating the exemplary embodiment of the cam lock wrench of FIG. 1, according to a preferred embodiment of the present invention;

FIG. 7 FIG. 5 is a front-side elevation view illustrating the exemplary embodiment of the cam lock wrench of FIG. 1 engaged with a portion of a cam lock lever, according to a preferred embodiment of the present invention;

FIG. 8 is a side elevation view illustrating a first section of prior art hose;

FIG. 9 is a side elevation view illustrating a second section of prior art hose;

FIG. 10 is a top perspective view illustrating a portion of the second section of the prior art hose of FIG. 9;

FIG. 11 is a top perspective view illustrating a portion of the second section of the prior art hose of FIG. 9;

FIG. 12 is a side-top perspective view illustrating a portion of the second section of the prior art hose of FIG. 9 with the cam lock wrench of FIG. 1 engaged, according to a preferred embodiment of the present invention;

FIG. 13 is a side elevation view illustrating a second exemplary embodiment of a head of a cam lock wrench, according to a preferred embodiment of the present invention;

FIG. 14 is a side elevation view illustrating the second exemplary embodiment of a head of a cam lock wrench of FIG. 13 engaged with a cam lock lever, according to a preferred embodiment of the present invention;

FIG. 15 is a side elevation view illustrating a third exemplary embodiment of a cam lock wrench, according to a preferred embodiment of the present invention;

FIG. 16 is a rear plan view illustrating a head of the cam lock wrench of FIG. 15, according to a preferred embodiment of the present invention;

FIG. 17 is a front plan view illustrating a handle of the cam lock wrench of FIG. 15, according to a preferred embodiment of the present invention;

FIG. 18 is a rear plan view illustrating the handle of the cam lock wrench of FIG. 15, according to a preferred embodiment of the present invention;

FIG. 19 is a front-end elevation view illustrating a second exemplary embodiment of a cam lock wrench, according to a preferred embodiment of the present invention; and

FIG. 20 is a front-side perspective view illustrating the exemplary embodiment of the cam lock wrench of FIG. 1 with a traction enhancement, according to a preferred embodiment of the present invention.

### DETAILED DESCRIPTION OF THE INVENTION

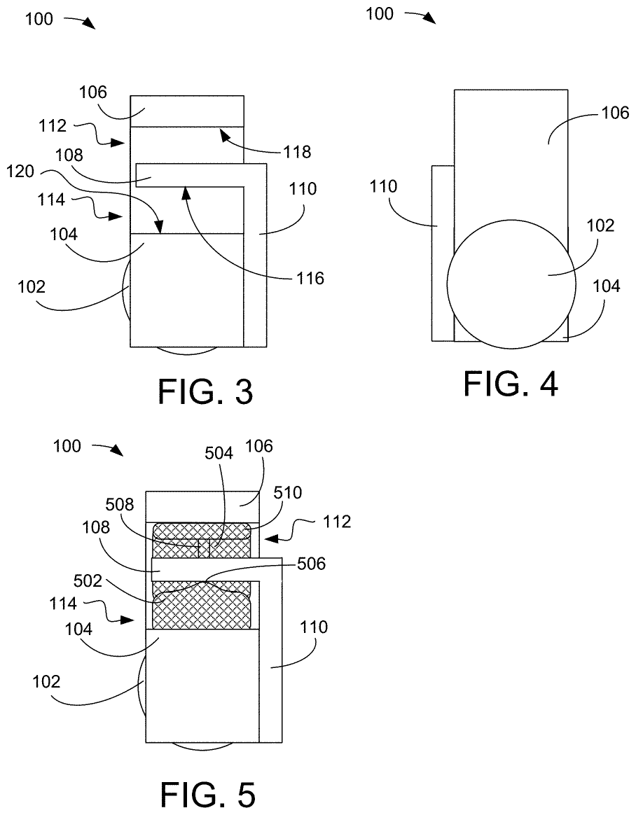

As used and defined herein, terms of position and orientation such as “underside”, “top”, “bottom”, “front”, “rear”, etc., are referred to the orientation of FIGS. 3-7.

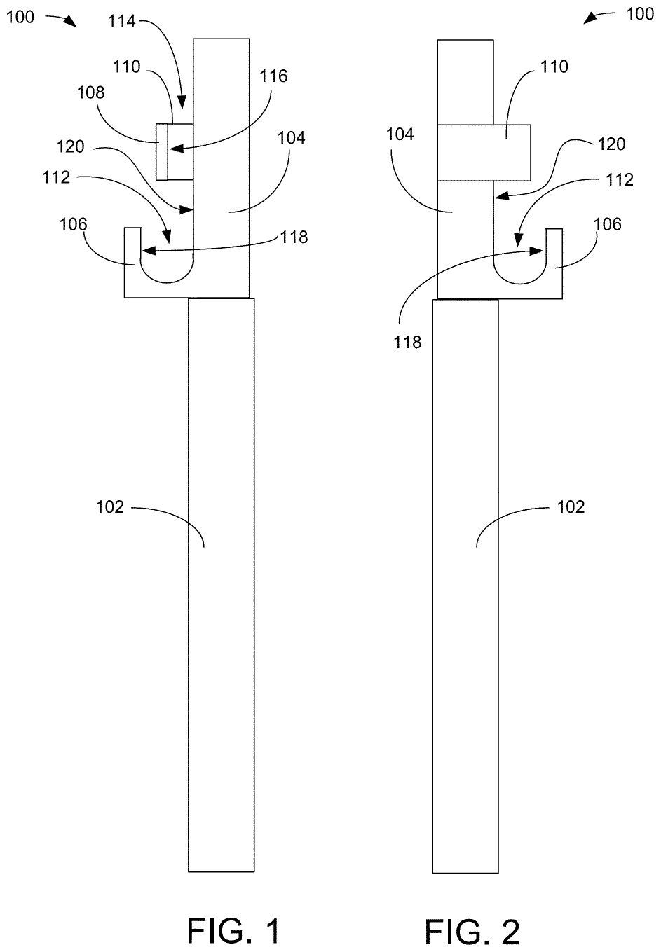

FIG. 1 is a right-side elevation view illustrating an exemplary embodiment of a cam lock wrench 100, according to a preferred embodiment of the present invention. Cam lock wrench 100 has a handle 102 fixed to a head 104. Handle 102 is illustrated herein as a cylindrical rod, but the invention is not so limited. Various designs of handle 102 may be used, such as those having polygonal or irregular cross sections, surface configurations for improving grip, and ergonomic handles 102. Handle 102 is preferably constructed of steel, for work in oil fields. For various other embodiments, other materials may be preferred. For non-limiting example, a cam lock wrench 100 made of 6061 aluminum may be preferred for use in oil fields. Other hard metal alloys may be used in various embodiments.

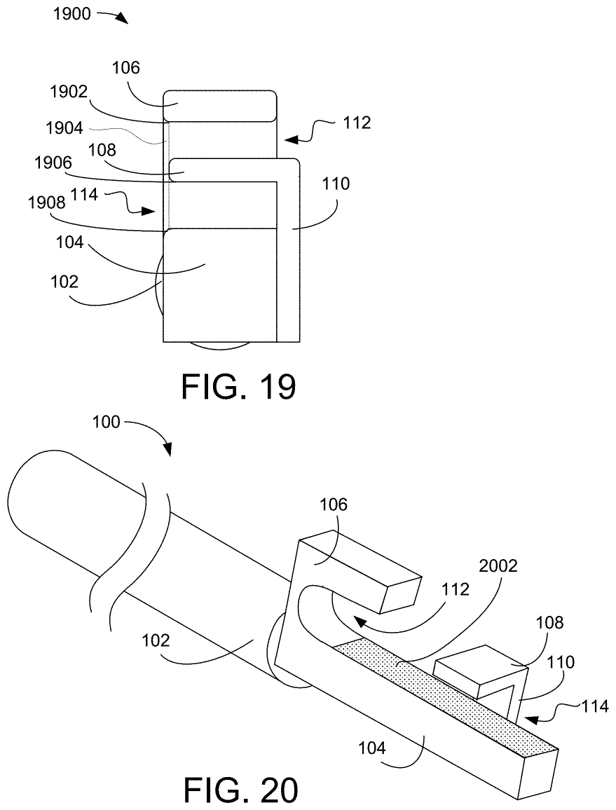

Head 104 is preferably of one piece with handle 102 and is configured to enable engagement with a cam lock lever 502 (see FIG. 5) from the side. Rear member 106 extends from head 104 to create an arcuate cavity 112 sized to slidingly receive and engage the cam lock lever head 504 (see FIG. 7) between underside surface 118 of rear member and opposing surface 120 of head 104. Front member 110 is extends from head 104 and supports top panel 108 to create a channel 114, between the underside surface 116 of top panel 108 and the opposing surface 120 of head 104, for receiving the cam lock lever 502 (see FIG. 7). Head 104 and associated members 106, 108, and 110 are preferably made out of steel, 6061 aluminum, or other hard metal alloys of similar strength. In a particular embodiment, head 104 is fixed to handle 102 by, for non-limiting example, welding. In various other embodiments, other means, such as fastening and adhering, may be used. In a preferred embodiment, cam lock lever 100 is made of one piece. Variations in the shape of members 106, 108, and 110 which do not degrade function are within the scope of the invention. For non-limiting examples, rounded edges 1902, 1904, 1906 and 1908 (see FIG. 19), making slightly narrower or wider, contour variations on surfaces that to not directly engage any part of the cam lock lever 502 and cam lock lever head 504, and traction enhancement 2002 (see FIG. 20) to surfaces 116, 118, and/or 120 that do engage parts of the cam lock lever 502 and cam lock lever head 504 may be used.

FIG. 2 is a left side elevation view illustrating the exemplary embodiment of the cam lock wrench 100 of FIG. 1, according to a preferred embodiment of the present invention. In a particular embodiment, front member 110 and top panel 108 may be a single L-shaped part. Head 104 may be made by casting, machining, water jet cutting, welding, combinations thereof, and similarly effective means. In a preferred embodiment, head 104 and handle 102 are made of one piece by casting or machining.

FIG. 3 is a front-end elevation view illustrating the exemplary embodiment of the cam lock wrench 100 of FIG. 1, according to a preferred embodiment of the present invention. The size of the handle 102 to the size of the head 104 is not a limitation of the invention. The front member 110 and top panel 108 is shown as an L-shaped structure. Various sizes of cam lock levers 502 are used in industry, and cam lock wrenches 100 can be sized for each.

FIG. 4 is a rear end elevation view illustrating the cam lock wrench 100 of FIG. 1, according to a preferred embodiment of the present invention. Preferably, rear member 106 is of one piece with head 104. In various other embodiments, rear member 106 may be attached to head 104.

FIG. 5 is a front-end elevation view illustrating the exemplary embodiment of the cam lock wrench 100 of FIG. 1 engaged with a cam lock lever 502, according to a preferred embodiment of the present invention. Cam lock lever 502 is received and frictionally releasably retained in channel 114 between underside surface 116 of top panel 108 and opposing surface 120 (see FIG. 3) of head 104, and cam lock lever head 504 is received and frictionally releasably retained in arcuate cavity 112 between the underside surface 118 of rear member 106 and opposing surface 120 (see FIG. 3). Cam lock lever head 504 has a horizontal lip 510 and a vertical flange 508 for improved structural strength. Cam lock lever 502 has a ridge 506 for improved structural strength. In sizing channel 114 and arcuate cavity 112 for each of the various sizes of cam lock levers 502 and cam lock lever heads 504, respectively, the vertical flange 508 and lip 510 dimensions must be taken into account.

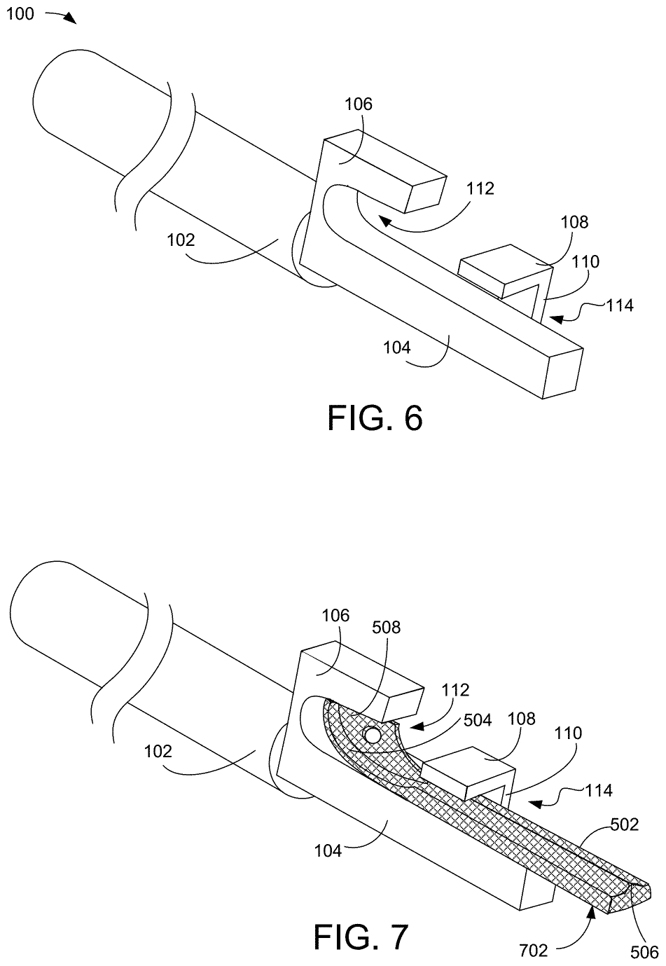

FIG. 6 is a front-side perspective view illustrating the exemplary embodiment of the cam lock wrench 100 of FIG. 1, according to a preferred embodiment of the present invention. Cam lock wrench 100 engages cam lock lever 502 from the side, capturing the cam lock lever head 504 in arcuate cavity 112 and the cam lock lever in channel 114.

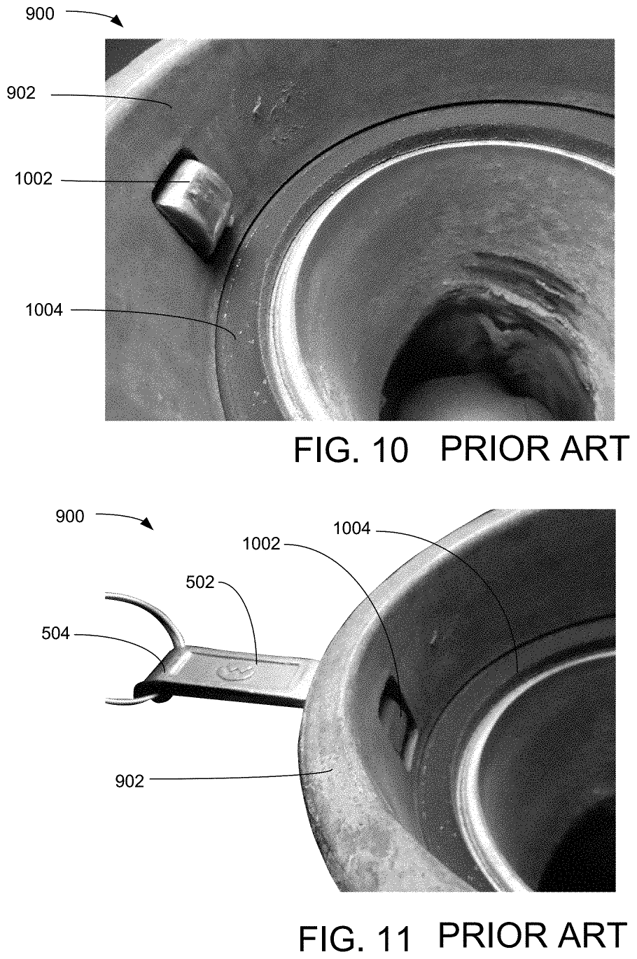

FIG. 7 is a front-side elevation view illustrating the exemplary embodiment of the cam lock wrench 100 of FIG. 1 engaged with a portion of a cam lock lever 502 and with cam lock lever head 504, according to a preferred embodiment of the present invention. Cam lock lever 502 has a ridge 506 for improved structural strength, and the dimensions of channel 114 must slidingly accommodate the dimensions of the cam lock lever 502 to enable sideways sliding engagement and frictional retention of the ridge 506 with the underside surface 116 of top panel 108 and of the underside surface 702 of the cam lock lever 502. Cam lock lever head 504 has a vertical flange 508 for structural strength. The cam portion 1002 (see FIG. 10) is omitted in this drawing. Lip 510 is not visible in this drawing.

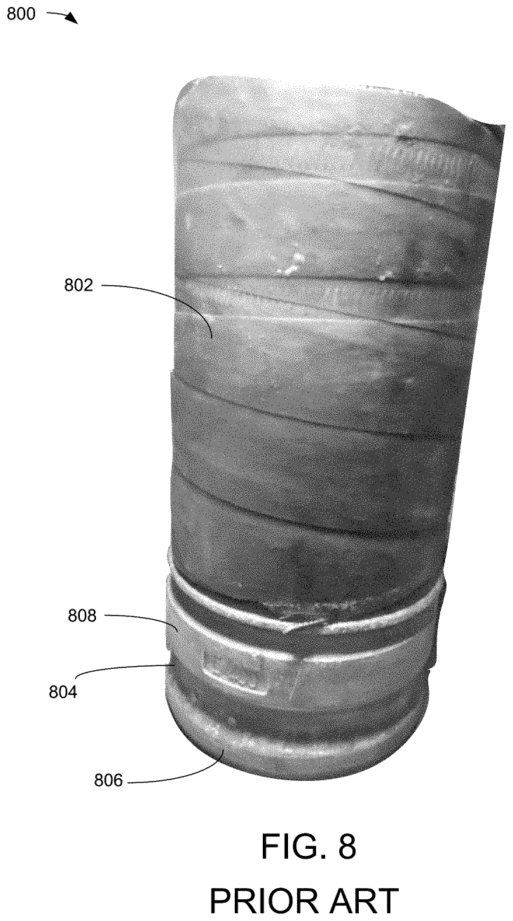

FIG. 8 is a side elevation view illustrating a first section of prior art hose 802. Prior art section of hose 802 is attached to a coupling 808 having a circumferential lip 806 and circumferential groove 804, as shown. Circumferential groove 804 receives the cam portion 1002 (see FIG. 10) of the cam lock lever 502 during locking operations. The cam portion 1002 forces circumferential lip 806 against resilient seal 1004 (see FIG. 10) to make a tight seal.

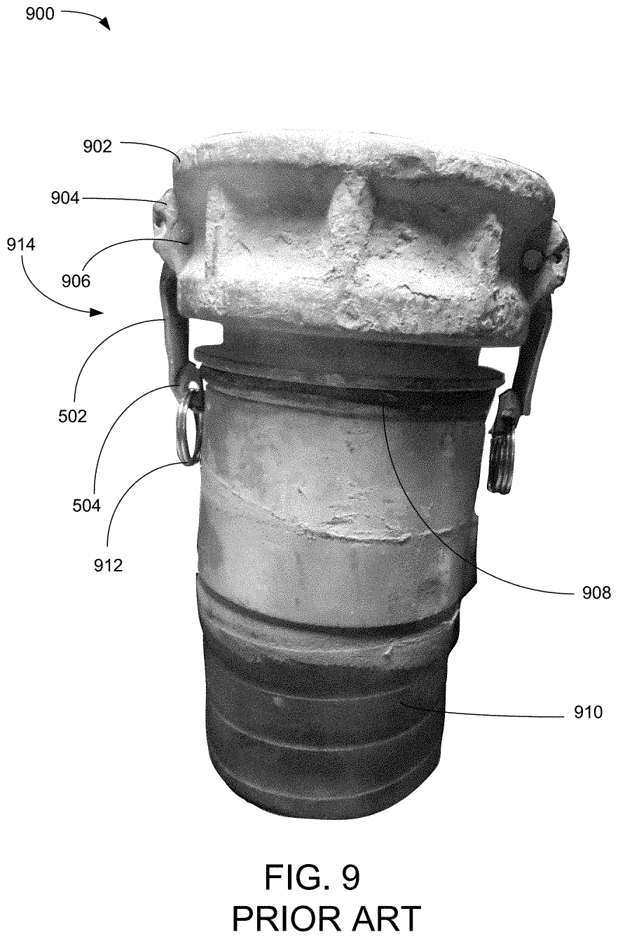

FIG. 9 is a side elevation view illustrating a second section of prior art hose 910. Second section of prior art hose 910 has an attachment 908 to a complementary coupling 902 which has a radially outward support 904 that supports a pivot 906 for the cam portion 1002 of cam lock lever 502 (one of two labeled), as shown. The cam lock 914 includes cam lock lever 502, cam lock lever head 504, pivot 906, cam portion 1002 (see FIG. 10), and resilient seal 1004 (see FIG. 10. Cam lock levers 502 are shown in the locked position. The rings 912 attached to the cam lock lever heads 504 do not interfere with the operation of the present invention. In field operations, rings 912 are often removed from cam lock levers 502.

FIG. 10 is a top perspective view illustrating a portion of the complimentary coupling 902 of the second section of the prior art hose 910 of FIG. 9. Cam portion 1002 of the cam lock lever 502 is shown in the locked position. Cam portion 1002 enters circumferential groove 804 and forces circumferential lip 806 against resilient seal 1004. More than one cam lock lever 502 is typically used on a complimentary coupling 902.

FIG. 11 is a top perspective view illustrating a cam portion 1002 of the cam lock lever 502 in the complimentary coupling 902 of the second section of the prior art hose 910 of FIG. 9. Cam lock lever 502 is shown in the unlocked position, with cam portion 1002 withdrawn from circumferential groove 804. This position is for inserting coupling 808 of prior art first hose section 802 into complimentary coupling 902 in order to lock the prior art hose sections 802 and 910 together.

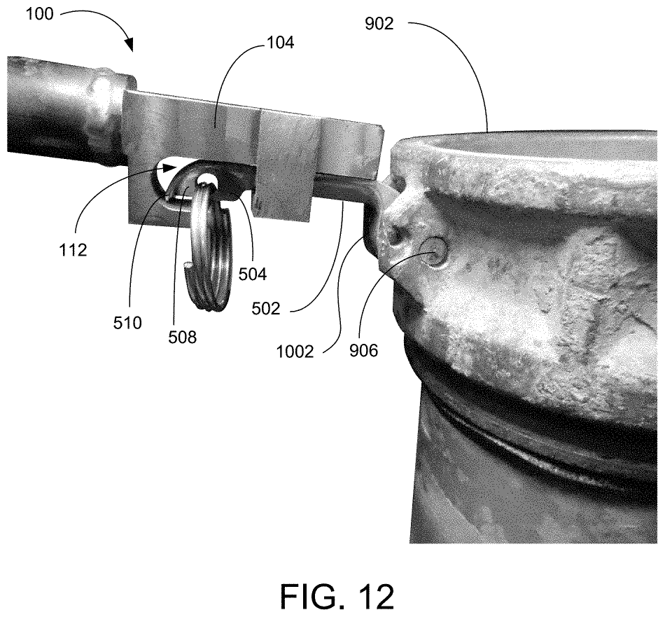

FIG. 12 is a side-top perspective view illustrating a portion of the complimentary coupling 902 of the second section of the prior art hose of FIG. 9 with the cam lock wrench 100 of FIG. 1 engaged, according to a preferred embodiment of the present invention. Cam lock lever head 504 is captured in arcuate cavity 112 and cam lock lever 502 is engaged in channel 114. Lip 510 engages the underside surface 118 (as shown) of rear member 106 in arcuate cavity 112 and opposing surface 120 of head 104 engages the underside surface 702 of cam lock lever 502, as shown. As also shown in FIG. 7, ridge 506 engages the underside surface 116 of top panel 108. In locking from this position, the contact of the cam lock lever head 504 with the underside surface 118 of rear member 106 in arcuate cavity 112 and the contact of the cam lock lever 502 in channel 114 enable leverage to easily lock the cam lock 914. Those of skill in art, enlightened by the present disclosure, will immediately see that leverage for opening the cam lock after locking is also available in this configuration. The rings 912 attached to the cam lock lever heads 504 do not interfere with the operation of the present invention, as shown.

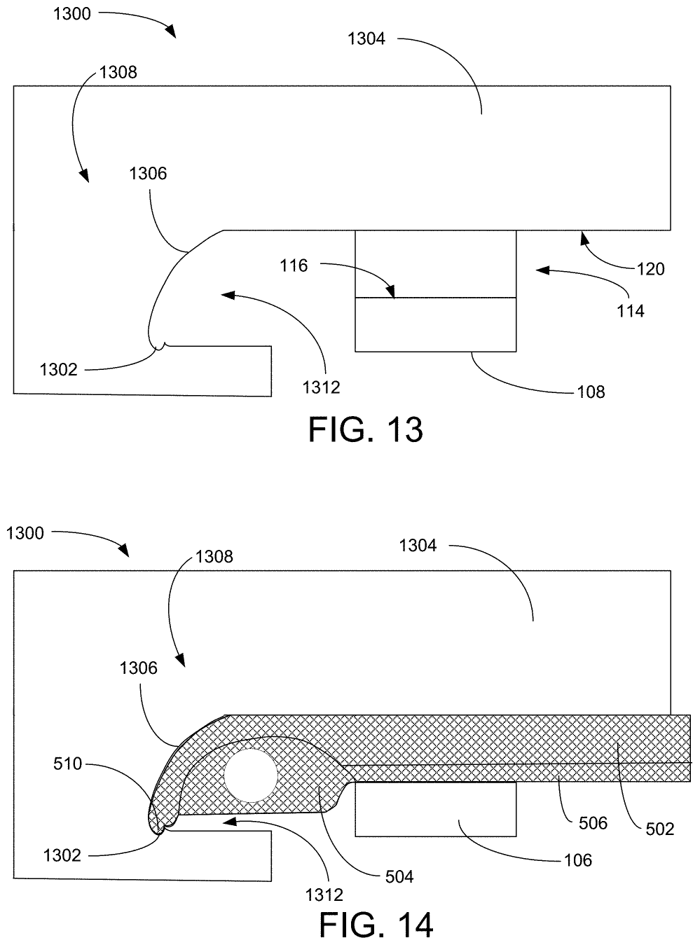

FIG. 13 is a side elevation view illustrating a second exemplary embodiment of a head 1304 of a cam lock wrench 1300, according to a preferred embodiment of the present invention. Head 1304 is similar to head 104 except that conformal cavity 1312 has been modified to follow the profile for cam lock lever head 504, in contrast to arcuate cavity 112 of FIG. 1. Head 1304 has a complimentary groove 1302 configured for receiving the lip 510 of the cam lock lever head 504. In some embodiments, the surface 1308 of head 1304 proximate the curved portion 1306 of conformal cavity 1312 and complimentary groove 1302 is beveled or rounded to make engagement with the cam lock lever head 504 easier. In some embodiments, the edges of channel 114 are beveled or rounded to make engagement with the cam lock lever 502 easier.

FIG. 14 is a side elevation view illustrating the second exemplary embodiment of a head 1304 of a cam lock wrench 1300 of FIG. 13 engaged with a cam lock lever 502, according to a preferred embodiment of the present invention. Lip 510 slides into complimentary groove 1302 and the curved portion of cam lock lever head 504 engages the curved portion 1306 of conformal cavity 1312.

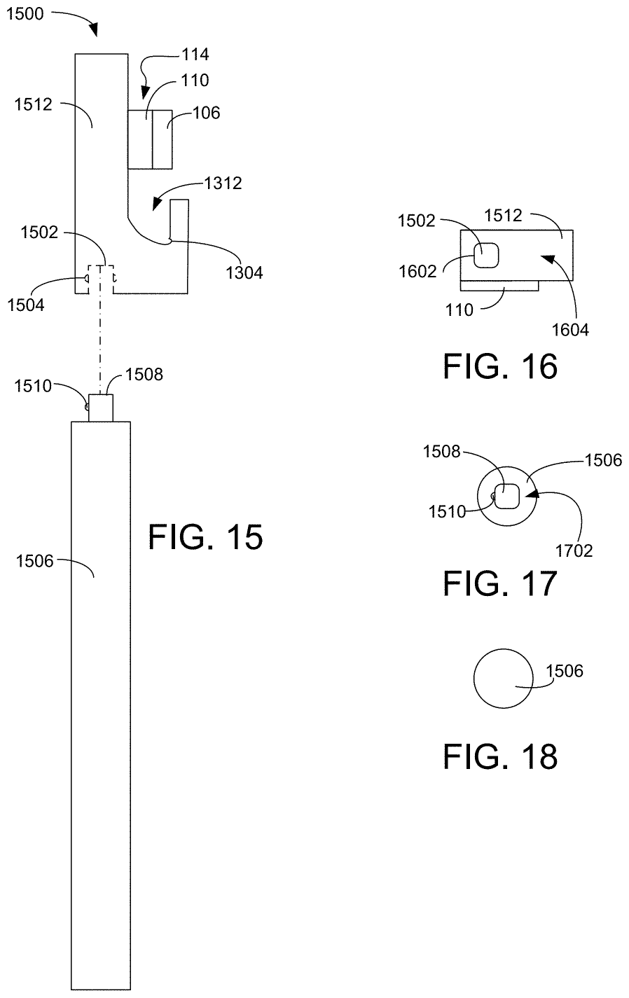

FIG. 15 is a side elevation exploded view illustrating a third exemplary embodiment of a cam lock wrench 1500, according to a preferred embodiment of the present invention. Head 1512 is similar to head 1304, except that head 1512 has a socket 1502, similar to a socket wrench socket, with four détentes 1504 (one labeled of two visible) that receive biased pin 1510 of socket wrench male portion 1508 extending from handle 1506. In some embodiments, conventional socket wrench extension bars may be used for handle 1506. In some embodiments, heads 1512 of various sizes may be packaged together for sale with or without socket wrench extension bars sized appropriately for the respective various heads 1512. In some embodiments, the end of the handle 1506 from which the male portion 1508 of the socket wrench coupling extends may be configured to engage the entire rear surface 1604 (see FIG. 16) of head 1512 for improved leverage. The illustrated size of the socket coupling parts 1502 and 1508 is not a limitation of the invention.

FIG. 16 is a rear plan view illustrating a head 1512 of the cam lock wrench 1500 of FIG. 15, according to a preferred embodiment of the present invention. Socket 1502 has a détente in each of four sides 1602 (one of four labeled) so that any rotational orientation of the male portion 1508 will connect. Rear surface 1604 of head 1512 is preferably smooth and flat for engagement with the surface 1702 (see FIG. 17) of the front end of handle 1506.

FIG. 17 is a front plan view illustrating a handle 1506 of the cam lock wrench 1500 of FIG. 15, according to a preferred embodiment of the present invention. A biased pin 1510 is disposed on one side of the male portion 1508, as shown. Front end surface 1702 is preferably smooth and flat for abutting engagement with head rear surface 1604.

FIG. 18 is a rear plan view illustrating the handle 1506 of the cam lock wrench 1500 of FIG. 15, according to a preferred embodiment of the present invention. The round cross sectional shape of handle 1506 is not a limitation of the present invention. For non-limiting examples, polygonal, conic section, and irregular cross sections may be used and the size and shape of the cross section may vary along the length of the handle 1506, as with a socket wrench extension or an ergonomic handle.

FIG. 19 is a front-end elevation view illustrating a second exemplary embodiment of a cam lock wrench 1900, according to a preferred embodiment of the present invention. Cam lock wrench 1900 has rounded edges 1902, 1904, 1906, and 1908 to ease sliding the cam lock lever 502 into cavity 112 and channel 114. Cam lock wrench 1900 is otherwise similar to cam lock wrench 100.

FIG. 20 is a front-side perspective view illustrating the exemplary embodiment of the cam lock wrench 100 of FIG. 1 with a traction enhancement 2002, according to a preferred embodiment of the present invention. Traction enhancement 2002 may be, without limitation, a texture, a coating, or a tape. Traction enhancement 2002 are preferably also added to surfaces 116 and 118, which are not visible in this view.

The following claims contain no statements of intended use. Functional claiming may be used.

I claim:

1. A cam lock wrench, comprising:
a. a wrench head having a cavity and a channel configured to receive and releasably retain a cam lock lever; and
b. a handle operable to support said head.

2. The cam lock wrench of claim 1, wherein said cavity and said channel are configured to receive said cam lock lever along a long side of said cam lock lever.

3. The cam lock wrench of claim 1, wherein said cavity comprises an arcuate cavity sized to receive a head of said cam lock lever.

4. The cam lock wrench of claim 1, wherein said cavity comprises a shape that is conformal to a head of said cam lock lever.

5. The cam lock wrench of claim 1, wherein said cavity comprises a groove configured to receive a lip of a head of said cam lock lever.

6. The cam lock wrench of claim 1, wherein said handle and said wrench head are of one piece.

7. The cam lock wrench of claim 6, comprising a hard metal alloy.

8. The cam lock wrench of claim 1, comprising a plurality of wrench heads each configured to receive and releasably retain a unique one of a plurality of cam lock levers of various designs.

9. The cam lock wrench of claim 1, comprising at least one traction enhancement at least in said channel and in said cavity.

10. The cam lock wrench of claim 1, comprising at least one rounded edge of said wrench head.

11. The cam lock wrench of claim 1, comprising a socket in a base of said wrench head adapted to receive and releasably retain a socket wrench male portion.

12. A cam lock wrench, comprising:
a. a wrench head having a cavity and a channel configured to receive and releasably retain a cam lock lever;
b. a handle operable to support said head; and
c. wherein said cavity and said channel are configured to receive said cam lock lever from a long side of said cam lock lever.

13. The cam lock wrench of claim 12, wherein said cavity comprises at least one of:
a. an arcuate cavity sized to receive a head of said cam lock lever;
b. a shape that is conformal to at least a portion of a head of said cam lock lever; and
c. a groove configured to receive a lip of a head of said cam lock lever.

14. The cam lock wrench of claim 12, wherein said handle and said wrench head are of one piece.

15. The cam lock wrench of claim 12, comprising:
a. a plurality of wrench heads each configured to receive and releasably retain a unique one of a plurality of said cam lock levers of various designs; and
b. a socket in a base of each said wrench head of said plurality of wrench heads adapted to receive and releasably retain a socket wrench male portion.

16. The cam lock wrench of claim 12, comprising a hard metal alloy.

17. The cam lock wrench of claim 12, comprising traction enhancements at least in said channel and in said cavity.

18. The cam lock wrench of claim 12, comprising at least one rounded edge of said wrench head.

19. A cam lock wrench, comprising:
a. a wrench head having a cavity and a channel configured to receive and releasably retain a cam lock lever;
b. a handle operable to support said wrench head;
c. wherein said cavity and said channel are configured to receive said cam lock lever along a long side of said cam lock lever;
d. wherein said cavity comprises at least one of:
i. an arcuate cavity sized to receive a head of said cam lock lever;
ii. a shape that is conformal to at least a portion of a head of said cam lock lever; and
iii. a groove configured to receive a lip of a head of said cam lock lever; and
e. comprising a hard metal alloy.

20. The cam lock wrench of claim 19, comprising at least one of:
a. a plurality of wrench heads each configured to receive and releasably retain a unique one of a plurality of cam lock levers of various designs;
b. at least one traction enhancement in one of said channel and said cavity;
c. at least one rounded edge of said wrench head; and
d. said handle and said wrench head formed of one piece.
